(19) United States
(12) Patent Application Publication
(10) Pub. No.: US 2021/0140107 A1
(43) Pub. Date: May 13, 2021

(54) WET METHOD FOR PRODUCING A PANEL OR A POLE, PRODUCTS PRODUCED BY SAID METHOD AND USE OF PRODUCTS PRODUCED BY SAID METHOD

(71) Applicants: SAINT-GOBAIN ISOVER, COURBEVOIE (FR); INSTITUT POLYTECHNIQUE DE GRENOBLE, GRENOBLE CEDEX 1 (FR); AGEFPI, SAINT-MARTIN-D'HERES (FR)

(72) Inventors: Evelyne MAURET, GRENOBLE (FR); Flavien LOZANO, MONTIGNE LE BRILLANT (FR); Martine RUEFF, GRENOBLE (FR); Julien THIERY, PARIS (FR); Ulrich PASSON, KARLSRUHE (DE)

(21) Appl. No.: 17/262,982

(22) PCT Filed: Aug. 2, 2019
(86) PCT No.: PCT/FR2019/051898

§ 371 Date: Jan. 25, 2021

(30) Foreign Application Priority Data
Aug. 3, 2018 (FR) 1857286
Jan. 10, 2019 (FR) 1900251

(51) Int. Cl. D21F 11/14; D21H 13/40; E04B 1/80; D21H 11/18

(52) U.S. Cl. CPC D21F 11/145; D21H 11/18; E04B 1/803; D21H 13/40

(57) ABSTRACT

A method of making a board or mat, includes forming a liquid slurry with solids including inorganic fibers and cellulose fibers, forming a web from the slurry on at least one foraminous element, extracting water from the web, and drying the web to make a product, wherein the pH of the liquid slurry including the inorganic fibers and cellulose fibers is in the pH range of 2-6 and wherein the cellulose fibers have a Schopper-Riegler index of ≥50 according to ISO 5267.

The invention relates to a method for making a board or mat by wet process, a product made in accordance with this process and a use of this product.

The use of man-made mineral fibers for thermal insulation of buildings and industrial facilities has been state of the art for many decades.

Manufacturing of mineral fiber boards may be performed by two processes well known to the expert. The conventional process, the so-called air-laid process, starts from a fiberisation of a molten glassy mass by rotary processes, such as internal or external centrifugation, also called TEL-process resp. REX process, or a nozzle blast process. These processes are described, e.g. in Ullmann's Encyclopedia of Industrial Chemistry, Vol. All, Fibers, 5. Synthetic Inorganic.

They are defined by a primary formation of fibers entrained by a flow of air together with other compounds optionally added into the fiber-containing gas stream, such as binders, onto a moving foraminous element to form a felt, which normally is further processed including a drying or a curing step to form a mat or a board.

A feature of these forming processes is an inherently laminar orientation of the mat or board formed with fibers, said fibers primarily being oriented in a horizontal direction. Depending on the intended use of the product, this laminar orientation may be beneficial for some properties, in particular thermal resistance, whereas it is less desirable when the main properties targeted are mechanical performance such as compression resistance or tear strength.

In order to overcome this drawback of the product resulting from air laid processing, various proposals have been made to increase the mechanical properties, e.g. by re-orienting the fibers in the felt prior to drying or curing.

One application sector which is sensitive to mechanical properties is the use of mineral fiber board or mat elements as core material of vacuum insulation panels. Due to the core material being embedded in an air-tight foil material, which is evacuated, the core material has to withstand atmospheric pressure during the entirety of the service life of the vacuum insulation panel. Although the mechanical properties may be increased by increasing the raw density or by increasing the binder content, the first option is disliked due to high weight and material needs, while the latter option has the drawback that a binder may decompose and thus deteriorate the vacuum, thereby increasing the inner pressure. As a consequence, the service life of the vacuum insulation panel may be significantly affected.

As an alternative, products with high requirements for mechanical properties may be made by a wet process, which differs from air laid forming in that the fibers of an air laid forming are collected and suspended in a liquid which is further processed.

WO00/70147 discloses a method of making a board or mat, which comprises forming a slurry with solids comprising inorganic fibers and cellulose fibers, followed by forming a web from the slurry on at least one moving foraminous element. The water is extracted from the web and the web is dried by passing elevated temperature air through the web. The objective of the process is to provide a process which allows the production of mineral fiber boards particularly using recycled fiberglass, mineral fibers, rock wool or other inorganic fibers as the input fibers, which have enhanced uniformity and compressive strength compared to boards produced with an air laid process. Other fibers such as aramid, thermoplastic and cellulose fibers may be added to the mineral fibers. The products produced according to WO00/70147 do in most circumstances comprise a binder, although the process allows the manufacture of products without any binder.

However, there still is an interest to provide mineral fiber based products having high mechanical properties, particularly compression strength and/or tensile strength, for applications requesting such properties, especially a core material for a vacuum insulation panel, as filter material, esp. a filter paper, or as a battery separator.

The objective is achieved through a method of making a board or mat, comprising:
forming a liquid slurry with solids comprising inorganic fibers and cellulose fibers,
forming a web from the slurry on at least one foraminous element, preferably a moving foraminous element,
extracting water from the web, and
drying the web to make a product, characterized in that
the pH of the slurry comprising the inorganic fibers and cellulose fibers is in the pH range of 2-6, and
in that the cellulose fibers have a Schopper-Riegler index of 50 according to ISO 5267.

A product made according to this method also achieves this objective. In terms of use, the objective is achieved by the use of said product as a core material of a vacuum insulation panel or as filter material, in particular as filter paper or as a battery separator.

The present invention concerns in particular a method of making a board or mat, which comprises the steps of:
forming a slurry with solids comprising inorganic fibers and cellulose fibers,
forming a web from the slurry on at least one foraminous element; preferably a moving foraminous element,
extracting water from the web, and
drying the web to make a product,

wherein the pH of the slurry comprising the inorganic fibers and cellulose fibers is in the pH range of 2-6 and

wherein the cellulose fibers have a Schopper-Riegler index of 50 according to ISO 5267

The web may have any thickness, thus it may be as thin as paper. In order to produce a product of a desired thickness, it may be necessary to foresee a step of layering a multitude of web layers onto each other by known processes such as folding, stacking and alike.

The Schopper-Riegler index, which is determined according to ISO 5267, is a measure to determine the index of refining. Refining allows, among other things, defibrillation of the fiber wall by a liberation of macrofibrils, which gives rise to a greater number of interfiber connections in the end product. Such a rise in the interfiber connections increases mechanical properties of the end product.

The inventors have recognized that the compressive strength and/or the tensile strength are substantially increased when the process is being performed with cellulose fibers in the specified range. This increase is due to the formation of hydrogen links between the cellulose fibers.

It is preferred, that the refined cellulose fibers have a Schopper-Riegler index of ≥60 according to ISO 5267 and/or a Schopper-Riegler index of ≤100 according to ISO 5267.

It is preferred that the pH value is in the range of 3 to 5, especially 3 to 4. Too acidic conditions demonstrated a deterioration of the compressive strength, while the positive effect declines as the pH value moves toward neutral.

Preferably the pH value is adjusted by a strong acid with an acid dissociation constant pKa equal to or less than 3, such as sulphuric acid or hydrochloric acid.

In a preferred embodiment of the invention, the inorganic fibers are chosen from mineral wool fibers, i.e. glass wool, stone wool or slag wool fibers, preferably made by a rotary or nozzle blast process. These fibers are available in large amounts at low costs.

It is preferred, that the micronaire of the inorganic fibers is 20 l/min, preferably 12 l/min, particularly 8 l/min.

The micronaire is thereby measured according to a known technique which is described in the patent application WO2003/098209. This patent application indeed relates to a device for determining the fineness index of fibers comprising a device for measuring the fineness index, said device for measuring the fineness index having, on the one hand, at least one first orifice connected to a measurement cell designed to receive a sample composed of a plurality of fibers and, on the other, a second orifice connected to a device for measuring a differential pressure situated on either side of said sample, said device for measuring the differential pressure being designed to be connected to a fluid flow production device, characterized in that the device for measuring the fineness index comprises at least one volumetric flowmeter for the fluid passing through said cell. This device provides correspondences between “micronaire” values and liters per minute (l/min).

A low fiber index, i.e. a low micronaire value implies a multitude of relatively thin, fine fibers. The use of fine fibers is beneficial to provide the product with high mechanical compression strength and improved lambda performance.

Preferably, the cellulose fibers are pulp fibers, especially wood pulp from softwood trees such as spruce, pine, fir, larch and hemlock, and hardwoods such as Eucalyptus, aspen and birch. The pulping process applied to produce the pulp may be standard pulping processes such as mechanical pulp, thermomechanical pulp (TMP), chemithermomechanical pulp (CTMP), chemical pulp (Kraft, sulfite and organosolv), recycled pulp. It is particularly preferred to use Kraft pulps, in particular chemically bleached Kraft wood pulp from softwood trees such as spruce, pine, fir, larch and hemlock, and hardwoods such as eucalyptus, aspen and birch. The different pulps may be used independently or in various mixtures.

Especially preferred is the use of a bleached Kraft pulp of eucalyptus fibers. This material is available on the international market in large quantities at low cost.

It is preferred that the cellulose fibers have an arithmetic mean length between 0.2 mm and 5 mm and an arithmetic mean diameter between 10 μm and 70 μm.

The morphologic parameters length and diameter are measured using as measuring device an apparatus MorFi (Techpap, Grenoble, France) with a measuring method defining as fibers those elements whose length is in the range of 200 μm to 10 mm and whose diameter is between 5 μm and 75 μm. The fine fraction consists of elements with a length <200 μm and/or a width <5 μm.

The measuring principle comprises taking images of a fibrous suspension in flow with a CCD camera and processing the images using specific software for determining the morphology of the objects. Thus, the measurement is performed on the suspended fibers, i.e. on the pulped material. The average is calculated from a sample of at least 5000 fibers analyzed.

The refined cellulose fibers are characterized by the presence of macrofibrils visible at the external surface of the fiber wall. A measure of the macrofibril content is defined as

$$macrofibril content = \frac{sum ( length of the macrofibrils )}{length of the main fiber section} \qquad [ Math 1 ]$$

It is particularly preferred that the macrofibril content is between 0.1% and 1.5% (based on an evaluation of at least 300 fibers according to the above definition).

It is further preferred that the fine fiber content is 5 to 80%. The fine fiber content is thereby defined by the following equation:

$$fine fiber content = \frac{sum ( length of the fine fibers )}{\begin{matrix}sum ( l ength of the fine fibers ) + \\ sum ( length of the macrofibrils )\end{matrix}} \qquad [ Math 2 ]$$

Preferably, the share of inorganic fibers is equal to or greater than 90% and the share of cellulose fibers is greater than 0% up to 10%. In a particularly preferred embodiment, the share of inorganic fibers is between 92 and 98% and the share of cellulose fibers is between 2 and 8%. Especially it is preferred that the share of inorganic fibers is from 94 to 98% and that the share of cellulose fibers is from 2 to 6%. These % values refer to the weight of solids in the slurry.

Preferably, the share of other compounds contributing to forming the solid matter of the slurry is ≤3% by weight of solids. Such other, non-binder compounds may e.g. be opacifiers, fillers, dyes, etc.

It is further preferred that the slurry does not comprise any additional binder. Sufficient mechanical properties are provided by the synergistic interaction of the inorganic fibers and cellulose fibers that makes it possible to avoid the use of a binder in order to obtain enhanced mechanical properties. Further, binder-free products are of interest for a variety of particular applications, such as use as a non-offgasing/deteriorating core material for vacuum insulation panels.

In case of specific requirements for mechanical properties, the slurry may comprise a binder, which may particularly be added in a mass relation of 4 parts by weight of binder solid matter to 100 parts by weight of slurry solids without binder solid matter.

Specific protection is also requested for a product made according to the manufacturing process described above.

In a preferred embodiment, the raw density of a product exposed to a compression of 1 bar is ≤250 kg/m³, preferably ≤200 kg/m³ and most preferred ≤180 kg/m³

Preferably, the increase in raw density of a product exposed to a compression of 1 bar is below 150% of the raw density of the product exposed to a compression of 250 Pa, particularly below 100%. As a consequence, the product qualifies for use as core material for a vacuum insulation panel, due to its mechanical compression strength when exposed to the standard conditions of this particular application.

As a consequence, the product qualifies for use as core material for a vacuum insulation panel, due to its mechanical compression strength when exposed to the standard conditions of this particular application.

The compressibility measurement is carried out with a rigid-platen testing machine equipped with a measuring cell of 5 kN, for instance a Buchel-Van Der Korput press. The speed of the platens during the test is 1.4 cm/min and the selected measuring range is between 0 and 5000 N. The thickness at 250 Pa (ISO 29466:2008) is measured with a separate device. The surface subjected to pressure is 10×10 cm². This measured value corresponds to the reference thickness used for the calculation of the compressibility rate. Once the thickness at 250 Pa has been measured, 10 cm radius discs are placed on the bottom plate which rises so as to compress the mat. The sensor located above the device measures the perceived force on the upper plate. During this study, the compression is stopped when the force reaches the value corresponding to the pressure of 1 bar (3140 N for 20 cm in diameter test pieces), and the thickness is immediately measured. The pressure is maintained for 30 s. Then the bottom plate is lowered and the mat is released for 5 min, after which the compression procedure is repeated. In order to obtain a sufficient thickness (about 10 mm) to perform the compression tests, several test pieces with a radius of 10 cm are stacked.

Practical experience shows that the thickness after the 5 min pressure rest remains virtually constant over the long term. For practical reasons, thickness data are converted into raw density for the embodiments tested.

In a preferred embodiment, the tensile strength index of a product is at least 1.5 Nm/g, preferably at least 2.0 Nm/g, and most preferred at least 2.5 Nm/g, whereby the tensile strength index in the case of a dynamic production process using a moveable foraminous belt is measured in the running direction.

In case of a static production process, the tensile strength index does not show a big influence of orientation. In this case the tensile strength index is the lower of the tensile strength indices in both orientations.

As a consequence, the product qualifies for use as a filter material, esp. a filter paper or a battery separator, both applications requiring increased tensile strength properties.

The tensile strength index (TSI) is determined as follows:

Tensile samples (150 mm×20 mm) are cut using a cutter (to limit edge effects) in the running direction as well as in the cross direction of the mat or sheet produced. The running direction represents the production direction of the machine, which in most cases shows a preferential orientation of the fibres. The cross direction is located perpendicular to the running direction.

These samples are then tested at a constant speed of 10 mm/min using a standard tensile force measuring apparatus, e.g. an INSTRON device connected to Bluehill acquisition software. The usual force cell for tensile strength tests of a 2 kN range sensor has been replaced by a force cell with a maximum capacity of 10 N to comply with typical breaking forces of the sample tested in the order of magnitude of about 1 N.

The tensile strength index is calculated from the tensile strength value at break (expressed in N), normalized by the width (20 mm), i.e. the test sample extension vertical to tear forces, and the grammage (expressed in g/m²) of the test sample for direct comparison using formula:

$$TSI = \frac{breaking force}{width \cdot surface weight} \qquad [ Math 3 ]$$

The invention will be more understood in detail from the description of advantageous embodiments.

### Preparation of Samples According to the Invention and Comparative Samples

A bleached Kraft pulp based on Eucalyptus commercialized by Cenibra, Brazil has been used as raw material for the cellulose fiber compound.

In a first step, the bleached Kraft pulp has further been pre-treated and refined in a refining apparatus PFI in accordance with ISO 5264. The refining index, i.e. the Schopper-Riegler index, has been determined for both the raw pulp and the refined pulps. This index is normalized according to ISO 5267. The refining of the bleached Kraft pulp is aimed at obtaining a Schopper-Riegler index of 40+/−5 for a first refined pulp and of 70+/−5 for a second refined pulp.

Table 1 shows the morphologic parameters of the raw bleached Kraft pulp and after the refining processes.

TABLE 1

| | Raw | Refined | Refined |
|---|---|---|---|
| | eucalyptus | eucalyptus | eucalyptus |
| Pulp | pulp | pulp 1 | pulp 2 |
| Schopper-Riegler Index [°SR] | 18 | 37 | 69 |
| Number of analyzed fibers | 5065 | 5066 | 5135 |
| Mean fiber arithmetic length [μm] | 679 | 686 | 633 |
| Mean fiber width [μm] | 20.7 | 21.9 | 23.3 |
| Macrofibril content [%] | 0.45 | 0.57 | 0.81 |
| Fine fiber content [% in length] | 22.0 | 19.7 | 27.2 |

In order to evaluate the influence of the Schopper-Riegler index on the tensile strength index, two further refined pulps 3 and 4 have been prepared analogously with a Schopper-Riegler index of 83 and 85 respectively.

Two different glass fibers, fiber 1 and fiber 2 with a micronaire of 18 l/min resp. 4 l/min were provided.

A liquid slurry comprising fiber 1 resp. fiber 2 and the refined eucalyptus pulp is formed, adjusted to a pH value of 3 by titration, and processed to a mat using a dynamic process. No additional binder has been added. The suspension is projected onto a wall of water formed on a rotating web in order to reproduce the orientation effect which is an important feature of a papermaking machine or a submerged forming machine. The dynamic formation has the effect of creating an anisotropic network in which the fibers are oriented in the direction of rotation of the drum, i.e. the running direction. This orientation of the fibers results in a difference in mechanical strength between the direction of the sheet and its perpendicular, the cross direction. The mat thus produced has been dried in an oven at a temperature of 130° C. until a constant mass is obtained. The process aimed at producing a sample having a grammage of 400 g/m² after drying for VIP core elements, while the target grammage for battery separator paper was 300 g/m² after drying.

Sample of the Product with Improved Compressive Strength Properties

In a first test, embodiments have been accordingly produced with Fiber 1, at 6% by weight of solids of refined eucalyptus pulp using the three eucalyptus pulps of table 1 with different Schopper-Riegler indices.

The compressibility measure has been carried out with the Buchel-Van Der Korput press equipped with a measuring cell of 5 kN as described above.

Table 2 lists slurry parameter and raw densities of mats produced therefrom, which are calculated from the compressibility measure of the mats. Raw densities are given for the reference values at a load of 250 Pa and at a load of 1 bar.

TABLE 2
Slurry parameters and raw density of mats produced therefrom.

| | Fiber 1 | | | | | | |
|---|---|---|---|---|---|---|---|
| | [% by | | | | | | |
| | weight of | | | | | | |
| | solids] | Refined | | | | | |
| | Glass | Eucalyptus | | pH of | Reference | | |
| | fiber | pulp [% by | | slurry | raw | | |
| | microna | weight of | | provided | density at | Raw density | Raw density |
| | ire | solids] | | for mat | 250 Pa | at 1 bar | increase* |
| | 18 l/min | See Table 1 | SR | forming | [kg/m³] | [kg/m³] | [%] |
| Exemplary | 94 | 6 | 67 | 3 | 118 | 221 | 87 |
| embodiment 1 | | | | | | | |
| Comparative | 94 | 6 | 37 | 3 | 135 | 284 | 110 |
| embodiment 1 | | | | | | | |
| Comparative | 94 | 6 | 18 | 3 | 171 | 484 | 183 |
| embodiment 2 | | | | | | | |

*The raw density increase is calculated by the ratio of (raw density at 1 bar—reference raw density)/reference raw density

The table shows that the Schopper-Riegler index has a significant influence on the mechanical properties of the products. When using a refined pulp with an SR index around 40, the raw density increases to about 280 kg/m³ at a load of 1 bar. For the untreated, unrefined pulp this raw density even increases to about 480 kg/m³. A raw density of 280 kg/m³, which would develop for a VIP (vacuum insulation panel) element in service under atmospheric pressure, is less accepted as it is quite high, thus making the VIP element heavier and potentially increasing the risk of seam weld and/or air-tightness covering layer damage. The raw density achieved with the untreated pulp is significantly too high to be used as a core material for a VIP element.

Exemplary embodiments and comparative embodiments have been made in analogy to the described steps, without pH adjustment or without adding the refined Eucalyptus pulp 2 with the highest Schopper-Riegler index of 67. The pH value of the liquid slurry without adjustment is about 9; it is mainly determined by the pH of the glass fibers used, the eucalyptus fibers added to the slurry having almost no effect on pH value.

As in the first test series, the compressibility measure has been carried out with the Buchel-Van Der Korput press equipped with a measuring cell of 5 kN as described above. Table 3 shows the list of slurry parameters and raw densities of the mats produced therefrom with a first fiber, which are calculated from the compressibility measure. As in Table 2, both the reference values for a load of 250 Pa and the values at a load of 1 bar are listed.

Table 4 lists the same parameters for a second fiber.

TABLE 3
Slurry parameters and raw densities of mats produced there from with a first fiber

| | | | | | | Raw density |
|---|---|---|---|---|---|---|
| | Fiber 1 [% by | Refined | | | | increase (raw |
| | weight of | eucalyptus | | | | density 1 bar— |
| | solids] | pulp 2 [% by | | Reference | | ref. raw |
| | Glass fiber | weight of | pH of slurry | raw density | | density)/ref. |
| | micronaire | solids] | provided for | at 250 Pa | Raw density at | raw density |
| | 18 l/min | See Table 1 | mat forming | [kg/m³] | 1 bar [kg/m³] | [%] |
| Exemplary | 94 | 6 | 3 | 118 | 221 | 87 |
| embodiment 1 | | | | | | |
| Exemplary | 97 | 3 | 3 | 153 | 296 | 93 |
| embodiment 2 | | | | | | |
| Comparative | 100 | — | 3 | Not | Not | |
| embodiment 3 | | | | measurable | measurable | |
| Comparative | 100 | — | 9 | Not | Not | |
| embodiment 4 | | | | measurable | measurable | |
| Comparative | 94 | 6 | 9 | 141 | 282 | 100 |
| embodiment 5 | | | | | | |
| Comparative | 97 | 3 | 9 | 159 | 578 | 264 |
| embodiment 6 | | | | | | |

TABLE 4
Slurry parameters and raw densities of mats produced therefrom with a second fiber

| | | | | | | Raw density |
|---|---|---|---|---|---|---|
| | Fiber 2 [% by | Refined | | | | increase (raw |
| | weight of | eucalyptus | | | | density 1 bar— |
| | solids | pulp 2 [% by | | Reference | | ref. raw |
| | Glass fiber | weight of | pH of slurry | raw density | | density)/ref. |
| | micronaire | solids] | provided for | at 250 Pa | Raw density at | raw density |
| | 4 l/min | See Table 1 | mat forming | [kg/m³] | 1 bar [kg/m³] | [%] |
| Exemplary | 94 | 6 | 3 | 107 | 160 | 50 |
| embodiment 3 | | | | | | |
| Exemplary | 97 | 3 | 3 | 97 | 277 | 134 |
| embodiment 4 | | | | | | |
| Comparative | 100 | — | 3 | 110 | 380 | 245 |
| embodiment 7 | | | | | | |
| Comparative | 100 | — | 9 | 136 | 536 | 294 |
| embodiment 8 | | | | | | |
| Comparative | 94 | 6 | 9 | 128 | 263 | 105 |
| embodiment 9 | | | | | | |
| Comparative | 97 | 3 | 9 | 103 | 454 | 341 |
| embodiment 10 | | | | | | |

A raw density could not be measured in case of comparative embodiments 3 and 4 due to the coarse structure of fiber 1 without any binding agent present. The finer fiber distribution of fiber 2 which provides a certain mechanical resistance against pressure load allowed raw density measurement.

The raw density data presented demonstrate that the raw density under load depends on the Schopper-Riegler index of the pulp used, the pH value of the slurry during mat forming and the amount of cellulose fibers/pulp. Particularly of interest is the SR index (see table 2 and result analysis). The increase of the pH from pH 3 to pH 9 leads to an increase of the raw density under load for identical other parameters (nature of glass fiber and glass fiber content, refined pulp content; e.g. exemplary embodiment 1 to comparative embodiment 7) with an increase in the raw density of at least 70 kg/m³, which is an excessive mass surplus compared to the exemplary embodiment.

Besides other advantages such as material costs, reduced raw density of the core material in VIP processing allows for faster operations, predominantly due to significantly reduced time for core evacuation, and as a general rule, improved thermal properties of the VIP core elements, due to a reduction of the heat conductivity of the core material.

In direct comparison, the raw density under 1 bar improves due to the influence of a modification of the pH value of the slurry during mat forming for both fiber 1 and fiber 2:
Comparative embodiment 5 in comparison with exemplary embodiment 1, from 282 kg/m³ to 221 kg/m³, i.e. about 21%.
Comparative embodiment 6 in comparison with exemplary embodiment 2, from 578 kg/m³ to 296 kg/m³, i.e. about 49%.
Comparative embodiment 9 in comparison with exemplary embodiment 3, from 263 kg/m³ to 160 kg/m³, i.e. about 39%.
Comparative embodiment 10 in comparison with exemplary embodiment 4, from 454 kg/m³ to 277 kg/m³, i.e. about 39%.

It has to be kept in mind that the raw density data for different fibers are not to be compared as such for the use as a core material for vacuum insulation panels. The different fiber morphology of fiber 1 and fiber 2 leads to differences in the thermal properties of the VIP elements with the corresponding core materials.

Besides the prime target of improved compressive strength, the test sample according to the invention further showed an increase in the tensile strength index. Due to compressive strength optimization, however, the increase was less significant compared to the tensile strength optimized products described in the following.

Product sample with improved tensile strength index

Test embodiments in both the running and cross direction have been prepared with glass fiber 1 (micronaire 18 l/min) and refined eucalyptus pulps 2, 3, and 4 in a dynamic process as described above aiming for a target grammage of 300 g/m². Embodiments made of glass fiber 1 and glass fiber 2 without addition of refined fibers have been produced as comparative examples.

Taking into account the findings as regards the influence of the pH, all embodiments, including comparative embodiments, have been produced at an increased pH of 3.

For all tested embodiments, the grammage, raw density—at a load of 250 Pa—and the tensile strength index (TSI)—according to the method described above—have been measured. The values for the embodiments in the running direction are summarized in the following table:

TABLE 5
Slurry parameters, raw densities and tensile strength indices of mats produced
therefrom

| | Fiber 1 [% | | | | | | |
|---|---|---|---|---|---|---|---|
| | by weight of | Refined eucalyptus | | | | | |
| | solids] | pulp | | | | Reference | Tensile |
| | Glass fiber | | [% by | | | raw density | strength |
| | micronaire | | weight of | | Grammage | at 250 Pa | index TSI |
| | 18 l/min | Nature | solids] | °SR | [g/cm²] | [kg/m³] | [Nm/g] |
| Exemplary | 97 | pulp 2 | 3 | 69 | 313 | 112 | 0.57 |
| embodiment | | | | | | | |
| 5 | | | | | | | |
| Exemplary | 95 | pulp 2 | 5 | 69 | 343 | 114 | 1.01 |
| embodiment | | | | | | | |
| 6 | | | | | | | |
| Exemplary | 93 | pulp 2 | 7 | 69 | 316 | 113 | 1.79 |
| embodiment | | | | | | | |
| 7 | | | | | | | |
| Exemplary | 90 | pulp 2 | 10 | 69 | 329 | 118 | 2.48 |
| embodiment | | | | | | | |
| 7 | | | | | | | |
| Exemplary | 97 | pulp 3 | 3 | 83 | 330 | 114 | 0.63 |
| embodiment | | | | | | | |
| 8 | | | | | | | |
| Exemplary | 95 | pulp 3 | 5 | 83 | 311 | 100 | 1.21 |
| embodiment | | | | | | | |
| 9 | | | | | | | |
| Exemplary | 93 | pulp 3 | 7 | 83 | 314 | 117 | 2.54 |
| embodiment | | | | | | | |
| 10 | | | | | | | |
| Exemplary | 90 | pulp 3 | 10 | 83 | 341 | 122 | 3.37 |
| embodiment | | | | | | | |
| 11 | | | | | | | |
| Exemplary | 97 | pulp 4 | 3 | 85 | 307 | 103 | 0.86 |
| embodiment | | | | | | | |
| 12 | | | | | | | |
| Exemplary | 95 | pulp 4 | 5 | 85 | 314 | 105 | 1.84 |
| embodiment | | | | | | | |
| 13 | | | | | | | |
| Exemplary | 93 | pulp 4 | 7 | 85 | 323 | 111 | 2.98 |
| embodiment | | | | | | | |
| 14 | | | | | | | |
| Exemplary | 90 | pulp 4 | 10 | 85 | 342 | 127 | 4.04 |
| embodiment | | | | | | | |
| 15 | | | | | | | |
| Comparative | 100 | — | | | 300 | 103 | 0.03 |
| embodiment | | | | | | | |
| 1 | | | | | | | |
| Comparative | 100 | — | | | 300 | 106 | 0.03 |
| embodiment | | | | | | | |
| 2 | | | | | | | |
| Glass fiber 2, | | | | | | | |
| micronaire 4 | | | | | | | |
| l/min | | | | | | | |

The tensile strength index as a function of refined eucalyptus pulp nature and concentration is also presented in FIG. 1. For the sake of visibility, comparative embodiment 2 is not depicted in FIG. 1.

While the tensile strength index for both comparative embodiment is very low, exemplary embodiments 5-15 demonstrate a steady increase of the tensile strength index depending on both pulp concentration and Schopper-Riegler index.

A preferred tensile strength index of at least 1.5 Nm/g is achieved by a combination of pulp content and Schopper-Riegler index for each pulp following the graphical presentation of FIG. 1.

Exemplary embodiment 7 (7% pulp 2, ° SR 69), exemplary embodiment 10 (7% pulp 3, ° SR 83) and exemplary embodiment 13 (5% pulp 4, ° SR 85) present a measured value above the preferred TSI.

Besides the prime target of improved tensile strength index, the test sample according to the invention further showed an increase in compression strength. Due to tensile strength optimization, however, the increase was less significant compared to that of the compression strength optimized products described above, particularly for application as a VIP core

1. A method of making a board or mat, comprising:
forming a liquid slurry with solids comprising inorganic fibers and cellulose fibers,
forming a web from the slurry on at least one foraminous element,
extracting water from the web, and
drying the web to make a product,
wherein
the pH of the slurry comprising the inorganic fibers and cellulose fibers is in the pH range of 2-6, and
wherein the cellulose fibers have a Schopper-Riegler index of ≥50 according to ISO 5267.

2. The method according to claim 1, wherein the cellulose fibers have a Schopper-Riegler index of ≥60 according to ISO 5267 and/or a Schopper-Riegler index of ≤100 according to ISO 5267.

3. The method according to claim 1, wherein the pH value is in the range of 3 to 5.

4. The method according to claim 1, wherein the pH value is adjusted by a strong acid with an acid dissociation constant pKa equal to or less than 3.

5. The method according to claim 1, wherein the inorganic fibers are mineral wool fibers.

6. The method according to claim 1, wherein the cellulose fibers are pulp fibers.

7. The method according to claim 1, wherein the micronaire of the inorganic fibers is ≤20 l/min.

8. The method according to claim 1, wherein the liquid slurry has a solids content of:
inorganic fibers: ≥90% by weight of solids
cellulose fibers: greater than 0% and up to 10% by weight of solids.

| | | Preferred | Most Preferred |
|---|---|---|---|
| | [% by weight | [% by weight | [% by weight |
| | of solids] | of solids] | of solids] |
| inorganic fibers | ≥90 | 92-98 | 94-98 |
| cellulose fibers | >0-10 | 2-8 | 2-8 |

9. The method according to claim 1, wherein the slurry does not comprise any additional binder.

10. The method according to claim 1, wherein the slurry comprises a binder in a mass relation of ≤4 parts by weight of binder solid matter to 100 parts by weight of slurry solids without binder solid matter.

11. A product made according to claim 1.

12. A product according to claim 11, wherein an increase in the raw density of the product exposed to a compression of 1 bar is below 150%, of the raw density of the product exposed to a compression of 250 Pa.

13. A product according to claim 11, wherein the raw density of the product exposed to a compression of 1 bar is ≤250 kg/m³.

14. A product according to claim 11, wherein the tensile strength index is at least 1.5 Nm/g.

15. A method comprising utilizing a product according to claim 11 as a core material of a vacuum insulation panel.

16. A method comprising utilizing a product according to claim 11 as filter material.

17. The method according to claim 1, wherein the at least one foraminous element is a moving foraminous element.

18. The method according to claim 3, wherein the pH value is in the range of 3 to 4.

19. The method according to claim 5, wherein the inorganic fibers are glass wool, stone wool or slag wool fibers, made by a rotary or by nozzle blast process.

20. The method according to claim 6, wherein the pulp fibers are wood pulp from softwood trees selected from the group consisting of spruce, pine, fir, larch and hemlock, or from hardwoods selected from the group consisting of eucalyptus, aspen and birch, or chemically bleached Kraft wood pulp from softwood trees selected from the group consisting of spruce, pine, fir, larch and hemlock, or from hardwoods selected from the group consisting of eucalyptus, aspen and birch.
